(19) United States
(12) Patent Application Publication
(10) Pub. No.: US 2023/0382010 A1
(43) Pub. Date: Nov. 30, 2023

(54) AUTOMATED SYSTEM FOR PRODUCING MANHOLE PRODUCTS AND ASSOCIATED METHOD

(71) Applicant: GCI Pipe Products, Inc., Shawnee, KS (US)

(72) Inventor: Kiran P. Giri, Leawood, KS (US)

(21) Appl. No.: 18/201,978

(22) Filed: May 25, 2023

Related U.S. Application Data
(60) Provisional application No. 63/346,573, filed on May 27, 2022.

(51) Int. Cl. B28B 15/00; B28B 17/00; B28B 7/38

(52) U.S. Cl. CPC B28B 15/005; B28B 17/0081; B28B 7/386; B28B 7/388

(57) ABSTRACT

An automated system and associated method of producing manhole products includes an area closed production loop where molds are moved to discrete workstations. A standard set of tasks (e.g., mold cleaning and release agent application, reinforcement placement, pre-pouring activities and inspection, filling, curing, and product demolding) are performed at various ones of the workstations. Once one of these tasks is completed, the mold moves to the next workstation. This enables a transition from ‘cast on the floor’ method to an assembly line principle.

This application claims the priority benefit of and expressly incorporates herein the entire disclosure of U.S. provisional application Ser. No. 63/346,573, filed May 27, 2022.

### BACKGROUND

This disclosure relates to a system and associated method for automated manufacture of manhole products particularly in automated precast system for forming manhole products such as manhole bases, risers, cones, etc.

Traditional wet cast production plant setups lack a “process flow” which makes it difficult to increase productivity and throughput.

A need exists for an improved arrangement that provides at least one or more of the above-described features, as well as still other features and benefits.

### SUMMARY

The present disclosure provides a system and related production method where an automated precast system provides improved efficiency in wet cast production of precast products through both automatization and optimization.

More particularly, a preferred arrangement of the present disclosure uses a closed production loop where forms are subjected to workstations. A standard set of tasks (e.g., form cleaning and release agent application, reinforcement placement, pre-pouring activities and inspection, filling, curing, and product demolding) are performed at each workstation. Once one of these tasks is completed, the forms move to the next workstation. This enables a transition from ‘cast on the floor’ method to an assembly line principle.

A preferred method includes forming a cast concrete manhole product by positioning a mold having a mold outer wall and a mold inner wall received therein on a pallet, opening the mold outer wall to access the mold inner wall, cleaning an external surface of the mold inner wall, closing the mold outer wall around the cleaned mold inner wall, moving the mold to a concrete pouring station, including sensing a position of the mold at a desired location in the concrete pouring station, then introducing concrete into the mold between the mold outer wall and the mold inner wall, subsequently moving the mold to a curing station, curing the molded manhole product; and separating the cured manhole product from the mold.

The mold opening step may include unlatching mating outer mold members and separating the outer mold members to access the mold inner wall.

The method may include applying a release layer to the mold.

The method may include positioning an insert in the mold to facilitate contour and passage formation of the manhole product.

The method may include securing the insert to the mold with a magnet.

The method may also include providing a movable cart that receives the mold thereon, and dimensioning the pallet for receipt on the cart.

The method may include providing a sensor on one of the pallet, cart, or mold to monitor a location of the mold.

The method may include installing forming members on the mold to define pin openings for subsequently mounting steps in the manhole product.

The manhole product forming method may include inserting a reinforcement member in the mold between the walls of the outer mold and the inner mold, and in one preferred embodiment includes forming the reinforcement member as an annular strengthening member cage, and positioning the annular cage between the outer mold wall and the inner mold wall.

The method may include installing an RFID tag in the mold.

The forming method may include using heat to accelerate the curing step.

The method may include using powered conveyors that receive the mold to transport the mold from one station to another station.

Benefits and advantages of the present disclosure will become more apparent from reading and understanding the following detailed description.

### BRIEF DESCRIPTION OF THE DRAWINGS

FIG. 1 is a schematic representation of a preferred plant layout.

FIG. 2 shows a mold for a manhole product located on a support surface or pallet which is received on a self-powered transfer cart.

FIG. 3 illustrates positioning of the transfer cart for advancement of the mold in pallet onto a conveyor.

FIG. 4 illustrates initial steps in opening a mold, namely, releasing the outer latches that hold first and second outer mold portions together.

FIG. 5 shows further separation of the outer mold portions from one another to gain access to the interior of the mold.

FIG. 6 shows access to an outer surface of the inner mold portion via the separated outer mold portions.

FIG. 7 illustrates extended inserts or mold pins extending outwardly from the inner mold portion for positioning between the inner mold portion and the outer mold portion.

FIG. 8 illustrates partially retracted positioning of the inserts/mold pins in the mold cavity between the inner mold portion and the outer mold portion.

FIG. 9 illustrates cleaning of interior surfaces of the mold portions.

FIG. 10 represents spraying of a release agent on the interior surfaces of the mold portions.

FIG. 11 illustrates positioning or insertion of a reinforcement member such as an annular reinforcement cage over the inner mold portion.

FIG. 12 represents forming of a mold insert.

FIG. 13 shows installing a preferred form of a completed mold insert into the mold cavity.

FIG. 14 shows positioning of the mold insert in the mold cavity and initial steps in closing the mold.

FIG. 15 shows initial steps in locking/latching the outer mold portion.

FIG. 16 shows the closed mold.

FIG. 17 illustrates movement of the closed mold on a conveyor.

FIG. 18 illustrates positioning of the mold at another workstation, for example, the pouring station.

FIG. 19 shows positioning of the poured mold at another workstation, for example, the curing station.

FIG. 20 illustrates a preferred sensor used in connection with starting and stopping movement of the transfer cart.

FIG. 21 illustrates use of proximity sensors in the system.

FIG. 22 represents incorporation of a programmable logic controller (PLC) for use on the transfer cart.

FIG. 23 represents how the transfer cart positions the next filled mold in the curing station.

FIG. 24 represents movement of the mold after the concrete has cured toward a stripping station.

FIG. 25 lists various attributes and features of the present disclosure.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

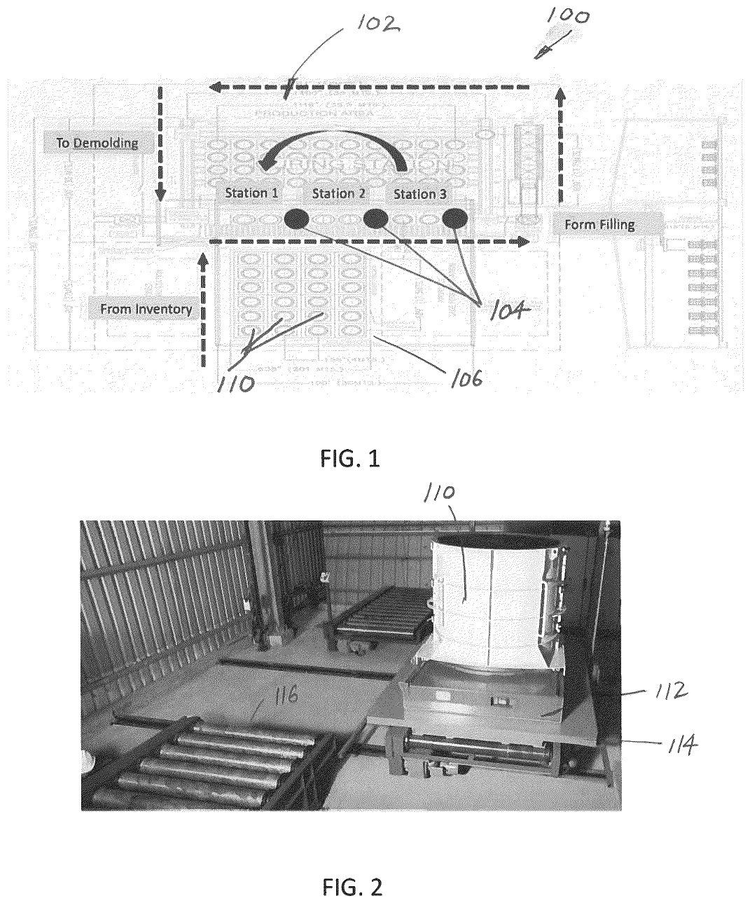

Turning initially to FIG. 1, There is schematically represented a floor plan for an automated system of producing manhole products such as manhole bases, manhole risers, and manhole cones. The system 100 and associated method of production preferably employ one or more closed production loops 102 that include a series of workstations 104. Three workstations 104 are illustrated in FIG. 1; however, the present disclosure is not limited to a particular number of workstations and instead this showing is simply representative of multiple workstations that perform one or more discrete steps at an individual workstation in the overall production process. Preferably adjacent the production loop 102 there is provided an inventory 106 of molds 110. Further, completed manhole products—each still held within an individual mold 110—are directed from the production loop 102 toward a demolding or stripping station (not shown) where the completed manhole product is separated from the mold.

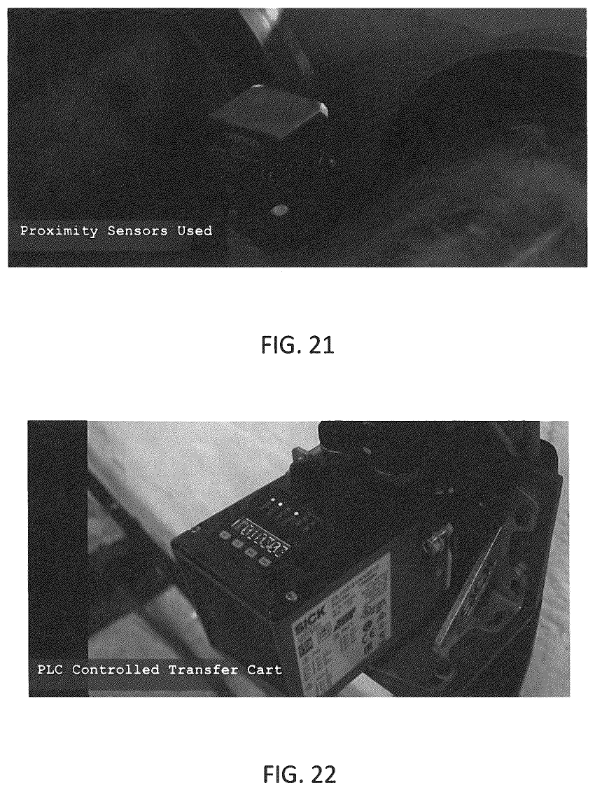

With continued reference to FIG. 1, and more specific reference to FIGS. 2-25, individual features of the process and the system 100 are shown and described in greater detail. FIG. 2 shows a mold 110 that includes a planar support or base member 112. The support member 112 is, in turn, received on a movable cart also referred to herein as a transfer cart 114. The transfer carts 114 as well as powered roller conveyors 116 provide effective movement of the mold 110 through the system 100. It is also contemplated that the transfer carts 114 may include self-contained motor drives for wheels in order that the transfer carts may be directed to deliver or receive an individual mold 110 to or from a workstation 104 where a particular workstation may not have a powered conveyor 116 interconnected with an adjacent workstation. In certain instances, it may be desirable to mount the powered conveyor in the floor, i.e., in a recess or pit so that the upper portions of the rollers are located at floor height in the production facility. In other instances, the transfer carts 114 are limited to transporting empty or filled molds 110 to and from the closed production loop 102 of the system 100.

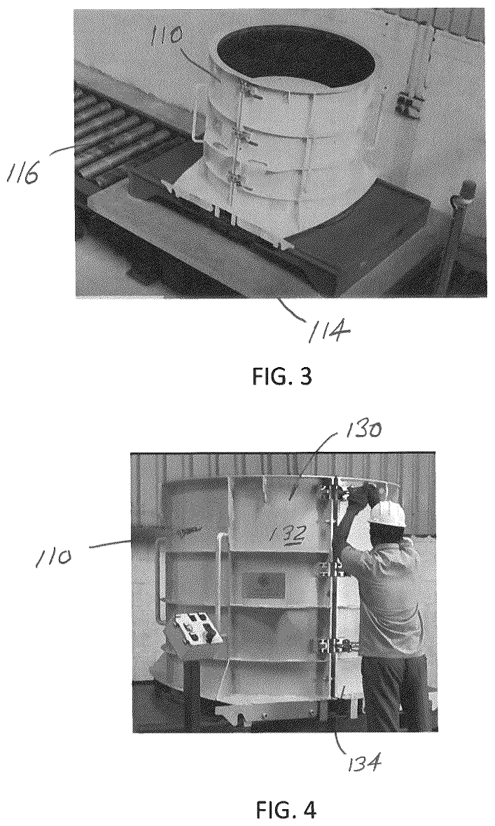

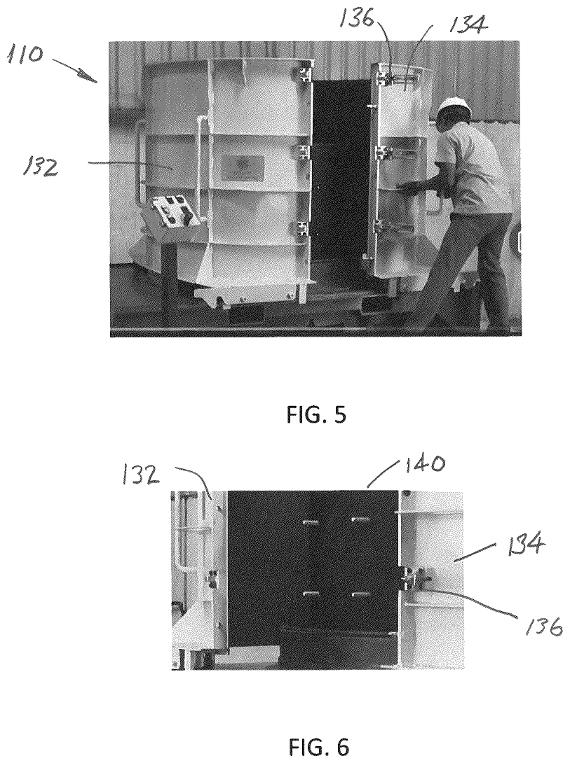

FIG. 3 illustrates conveyance of a pallet portion 115 of the transfer cart 114 that supports the mold 110 thereon to a powered conveyor 116. The conveyor 116 moves the mold 110 to a first station shown in FIGS. 4-11 (form cleaning and release agent application). Particularly, the mold 110 includes an outer mold wall 130 shown here as including first and second portions 132, 134 that are joined and held together by latches 136. The particular details of the latches 136 are not important to the function of the mold 110. Opening the latches 136 allows access to an interior cavity of the mold (FIG. 5). Received inside the outer mold wall 130 is an inner mold wall 140 (FIG. 6) to define an annular cavity between the inner and outer mold walls.

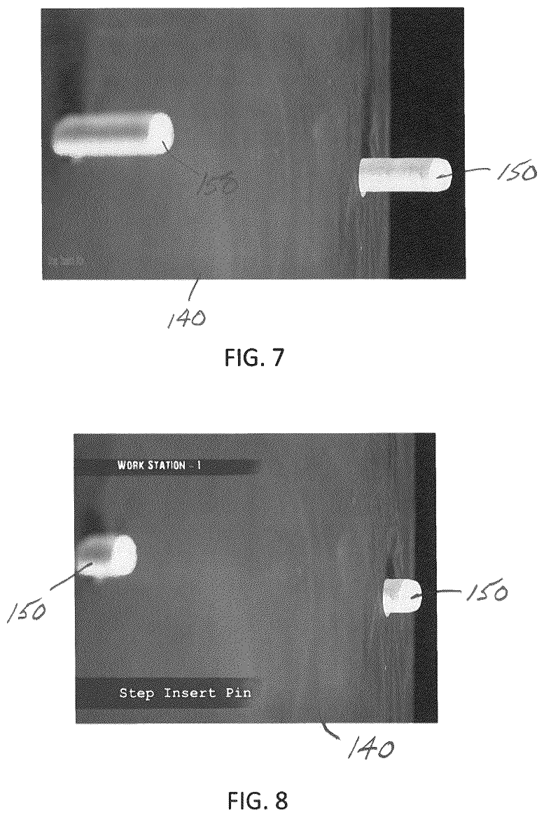

The enlarged views of FIGS. 7-8 of a portion of the inner mold wall 140 illustrate a series of pins 150 that extend into the cavity between the inner and outer mold walls. In this particular instance, the pins 150 are selectively extendible and retractable relative to the cavity so that when concrete is poured into the cavity, recesses or openings of a desired dimension are formed in the completed manhole product. For example, the openings or recesses formed in the completed cast product by the pins 150 in this exemplary embodiment are intended to receive conventional step rungs (not shown) that are mounted in the concrete structure. Of course other components or inserts can be provided in the annular cavity to accommodate and/or form a wide array of final features required in the manhole product.

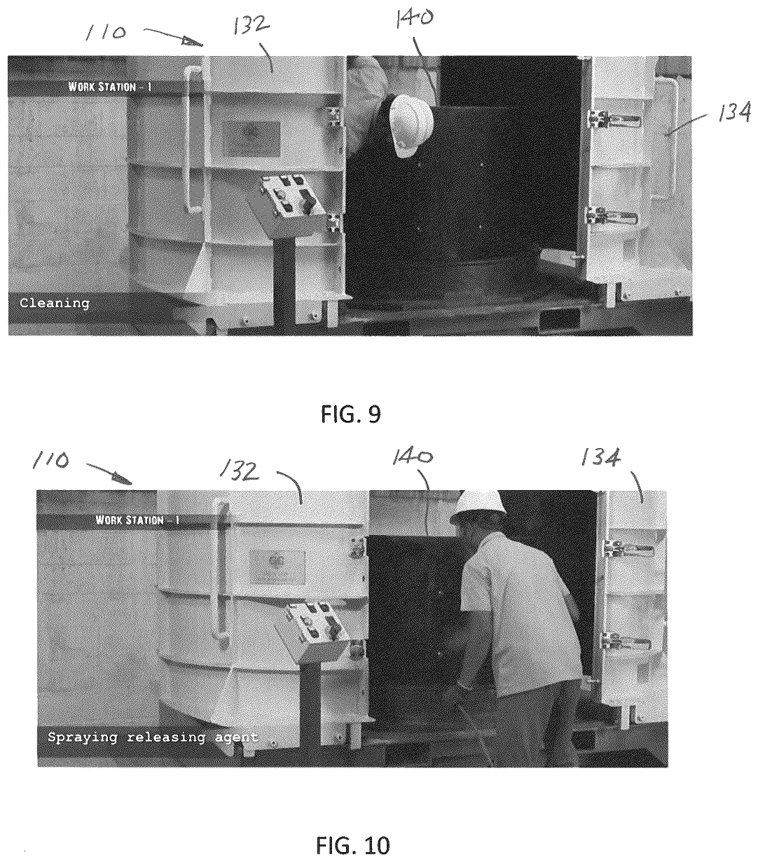

In FIG. 9, cleaning of the inner surface of the outer mold wall 130 and the inner mold wall 140 is preferably completed at the first workstation. The outer mold portions 132, 134 are sufficiently spread apart to allow access for desired cleaning equipment therein. Once the cleaning is complete, a suitable, conventional release agent is applied (e.g., sprayed) to the inner surfaces of the mold that define the cavity. In this manner, the cast concrete manhole product can be more easily separated from the mold.

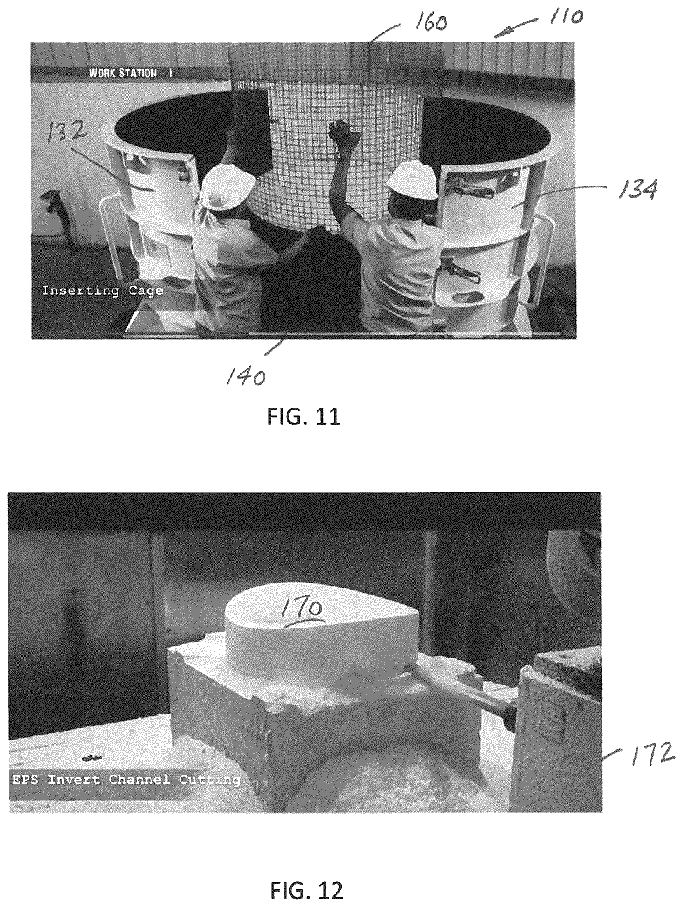

FIG. 11 shows either a second workstation, or show a further activity or task being completed at the first station. Again, the precise number of workstations may vary from one manhole product to another and the present disclosure should not be unduly limited by the number of workstations. In this instance, the method includes inserting a reinforcing member such as a metal mesh or annular cage 160 into the mold cavity between the outer surface of the inner mold wall and the inner surface of the outer mold wall. Again, separation of the first and second portions 132, 134 of the outer mold wall 130 facilitate insertion and proper placement or positioning of the reinforcing member 160 in the cavity.

FIG. 12 illustrates the forming of an insert 170 that is used to define the contour and passages formed in the manhole product. Here, a numerically controlled cutting or milling machine 172 can provide a customized insert that eliminates the use of pre-shaped foam sections that were subsequently assembled together (e.g., taped, glued, assembled foam sections to create an insert) and instead the CNC milling machine can provide customized design of a machined insert allowing for creating a specific number of passage, precision dimensioning, connections, etc.

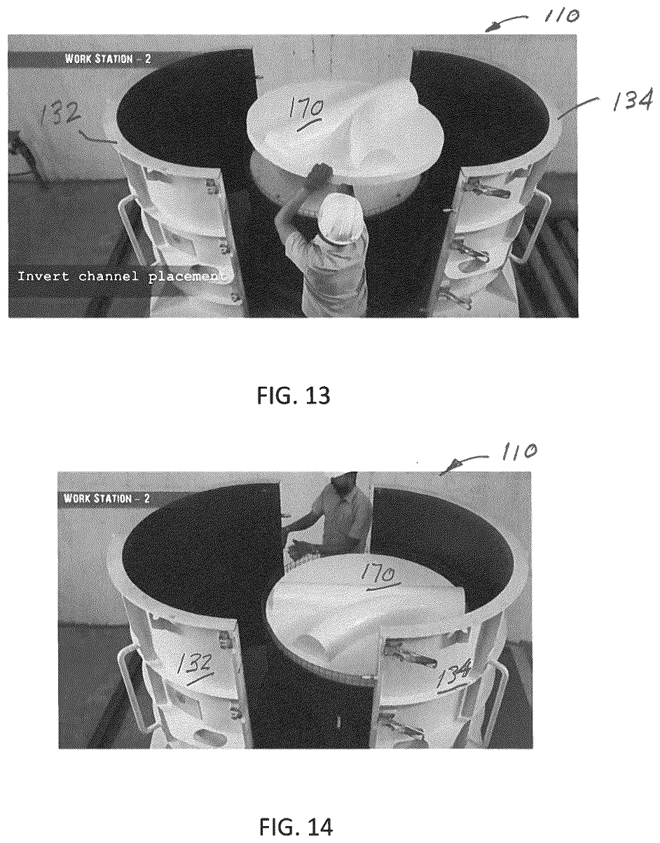

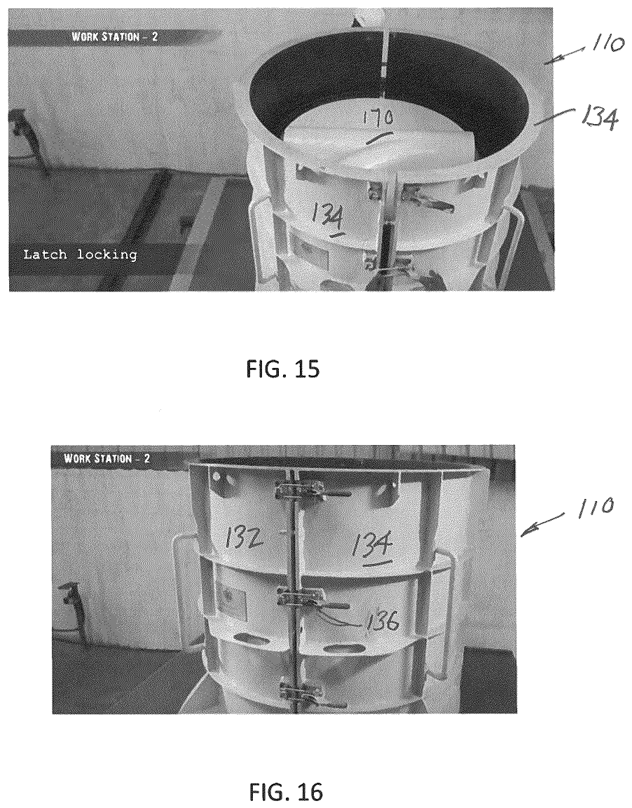

FIG. 13 illustrates positioning of the insert 170 into the mold 110. In this instance, the insert 170 is accurately located on a first or upper end of the inner mold wall 140, and is located within the upper end of the reinforcement member 160. It is contemplated that the insert 170 can be kept in placing by magnetically joining the insert to the mold 110 and, as shown in this embodiment, by magnetically securing the insert to the inner mold wall 140. Once the insert has been attached, the mold is closed as shown in FIG. 14-15, including securing together the latches of the outer mold wall portions 132, 134 (FIG. 16).

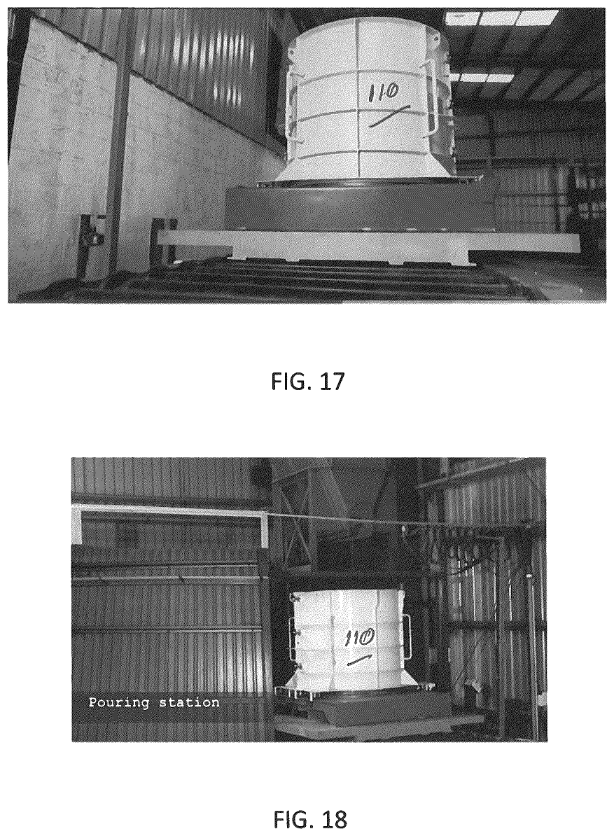

The closed mold 110 is then transported via the powered conveyor 116 (FIG. 17) to the next workstation (FIG. 18). This workstation is the filling or pouring workstation where concrete is directed into the cavity of the mold 110. This workstation may also include an oscillation table that supports the pallet surface of the transfer cart and the mold 110. The movement, vibration, or shaking of the mold 110 prevents air entrapment. Further, the filling workstation may include sensors such as laser controlled filling that monitors the amount of concrete poured into the mold.

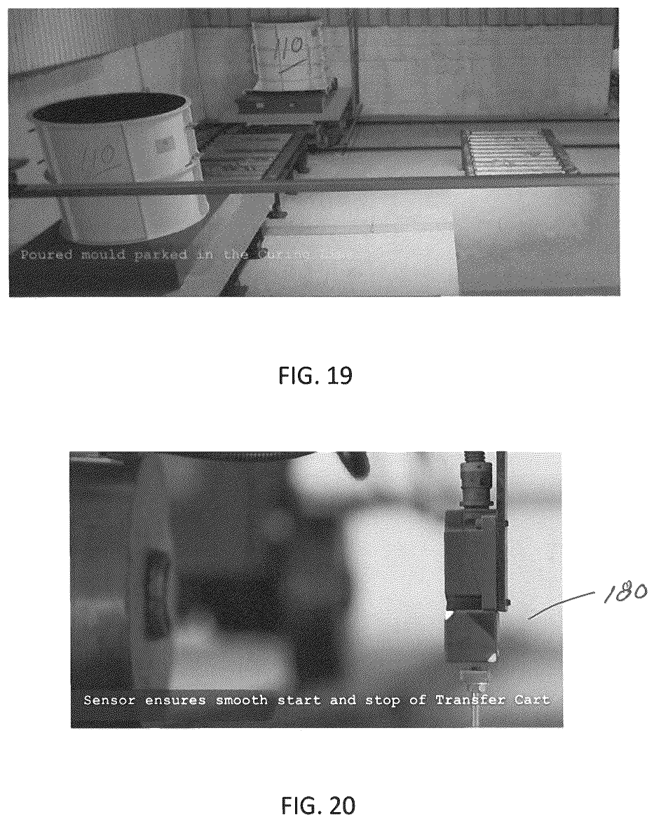

Once the filling step is complete, the filled mold is transported to a curing station or area (FIG. 19). Because the curing station may be more remotely located from the filling station, the transfer cart 114 may be used to convey the mold to a storage area.

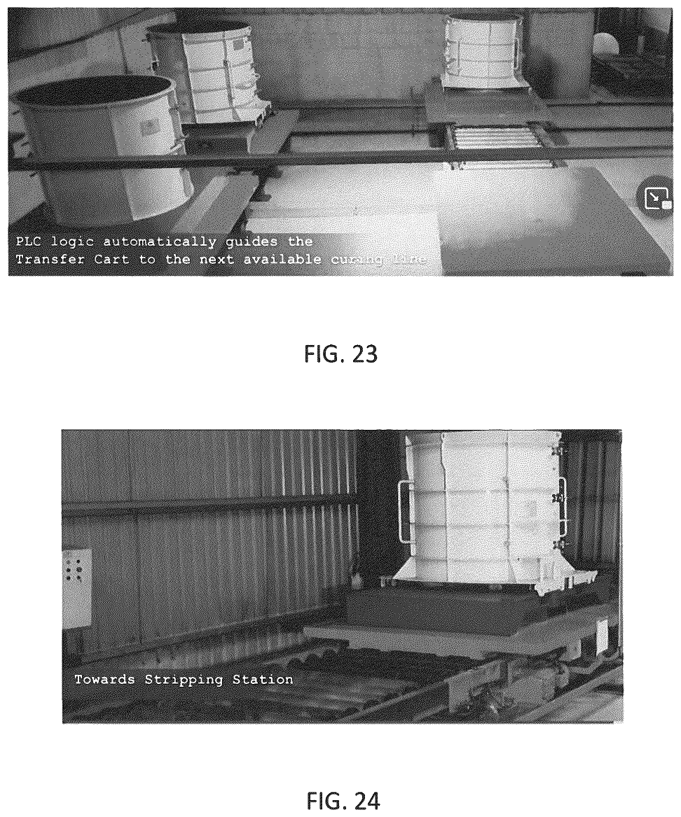

FIGS. 20, 21, and 22 illustrate various sensor that may be incorporated into the system. For example, the transfer cart 114 may include a sensor 180 (FIG. 20) that ensures a smooth start or stop of the transfer cart. Similarly, proximity sensors 190 may be used in one or more workstation(s) to accurately position the mold 110 at a desired position. Further, programmable logic controllers (PLC) may be incorporated into the drive mechanism of the transfer carts 114 to control the movement of the transfer cart within the overall production system (FIG. 23). RFID tags can be secured to either the molds, pallet portions or transfer carts to aid in location tracking of the molds or transfer carts.

Once the concrete has cured, the mold is transported to a stripping or demolding station where the concrete cast manhole product is removed from the mold 110 (FIG. 24).

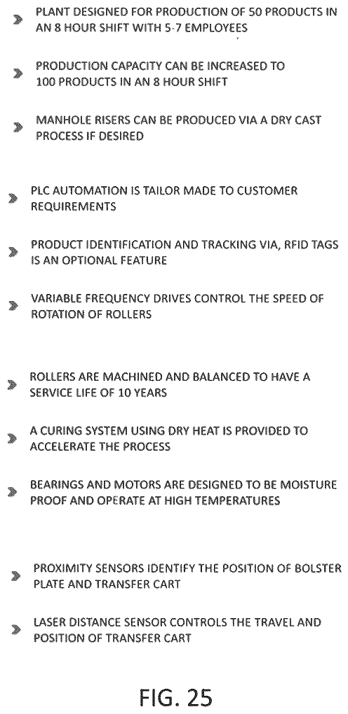

FIG. 25 lists some of the benefits and advantages that can be achieved with this system and production method.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

Exhibit A provides a technical and marketing summary of the above-described automated system and the associated method for producing manhole products such as manhole bases, manhole risers, and manhole cones.

It is claimed:

1. A method of forming a cast concrete manhole product comprising:
positioning a mold having a mold outer wall and a mold inner wall received therein;
opening the mold outer wall to access the mold inner wall;
cleaning an external surface of the mold inner wall;
closing the mold outer wall around the cleaned mold inner wall;
moving the mold to a concrete pouring station, including sensing a position of the mold at a desired location in the concrete pouring station;
then introducing concrete into the mold between the mold outer wall and the mold inner wall;
subsequently moving the mold to a curing station;
curing the molded manhole product; and
separating the cured manhole product from the mold.

2. The method of claim 1 wherein the mold opening step includes unlatching mating outer mold members and separating the outer mold members to access the mold inner wall.

3. The method of claim 2 further comprising applying a release layer to the mold.

4. The method of claim 1 further comprising positioning an insert in the mold to facilitate contour and passage formation of the manhole product.

5. The method of claim 4 further comprising securing the insert to the mold with a magnet.

6. The method of claim 1 further comprising providing a movable cart that receives the mold thereon, the pallet dimensioned for receipt on the cart.

7. The method of claim 6 further comprising providing a sensor on one of the pallet, cart, or mold to monitor a location of the mold.

8. The method of claim 1 further comprising installing forming members on the mold to define pin openings for subsequently mounting steps in the manhole product.

9. The method of claim 1 further comprising inserting a reinforcement member in the mold between the walls of the outer mold and the inner mold.

10. The method of claim 9 wherein the reinforcement member inserting step includes forming the reinforcement member as an annular strengthening member cage, and positioning the annular cage between the outer mold wall and the inner mold wall.

11. The method of claim 1 further comprising installing an RFID tag in the mold.

12. The method of claim 1 wherein the curing step includes using dry heat to accelerate the curing step.

13. The method of claim 1 further comprising using powered conveyors that receive the mold to transport the mold from one station to another station.

14. A cast concrete manhole product forming system comprising:
a mold having a mold outer wall and a mold inner wall received therein;
a mold cleaning station;
a concrete pouring station, including a sensor that positions the mold at a desired location in the concrete pouring station;
a curing station curing the molded manhole product;
a stripping station that separates the cured manhole product from the mold; and
at least one of a powered conveyor and a transfer cart that receives the mold thereon and transports the mold from the mold cleaning station to the pouring station, from the pouring station to the curing station, and from the curing station to the stripping station.

15. The system of claim 14 further comprising an insert in the mold to facilitate contour and passage formation of the manhole product.

16. The system of claim 15 further comprising a magnet for securing the insert in the mold.

17. The system of claim 14 further comprising a reinforcement member positioned between the outer mold wall and the inner mold wall.

18. The system of claim 14 further comprising an RFID tag in the mold to detect the location of the mold in plant.
